(19) United States
(12) Patent Application Publication
(10) Pub. No.: US 2010/0134271 A1
(43) Pub. Date: Jun. 3, 2010

(54) Hazard Ahead Warning Light and Method

(75) Inventors: Gary Thomas Edwards, Gardnerville, NV (US); Arthur Twiford Nemirow, Minden, NV (US); John E. Nemazi, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(73) Assignee: HAWL, LLC., Gardnerville, NV (US)

(21) Appl. No.: 12/628,572

(22) Filed: Dec. 1, 2009

Related U.S. Application Data
(60) Provisional application No. 61/200,458, filed on Dec. 1, 2008.

(51) Int. Cl. B60Q 1/52

(52) U.S. Cl. 340/471

(57) ABSTRACT

A hazard warning apparatus for use in motor vehicles enabling a driver observing a road hazard to warn other drivers. One embodiment is provided with at least one light preferably an array of lights arranged as a hazard warning signal mounted a body associated of the vehicle in a forward facing direction in order to warn oncoming traffic when illuminated. A power supply circuit provides an intermittently pulsed power signal to the array of lights for a limited period of time in response to an input signal and then automatically turns off. An input switch located proximate the driver when engaged communicates with the power supply causing the array of lights to be intermittently pulsed. In another embodiment the hazard warning apparatus communicates with other vehicles providing a hazard warning via a wireless signal.

### CROSS-REFERENCE TO RELATED APPLICATIONS

This application claims the benefit of U.S. provisional application Ser. No. 61/200,458 filed Dec. 1, 2008, which is incorporated by reference herein.

### BACKGROUND OF THE INVENTION

1. Field of the Invention

The present invention relates to the systems and methods for reducing vehicle collisions with deer as well as other roadway hazards.

2. Background Art

Most systems which are intended to minimize deer automobile collisions tend to try to scare the deer from the roadway or to warn drivers of areas in which deer frequently are present.

Deer warning signs with and without flashing warning lights have been the principal method of warning motorists of the potential presence of deer. These signs are often ignored by motorists. These “deer crossing” signs do not indicate that deer are actually present only that deer have been known to frequent that particular stretch of roadway.

So called “deer whistles” are mounted to vehicles to produce a sound that is claimed to scare deer off the roadway when a vehicle is in motion. Some studies claim that this device is ineffective. Further, devices like this or of similar design can in fact scare animals close to the road to dart the wrong way, and out into traffic rather than away.

Other sound making inventions are placed on the sides of roadways to produce sounds that report scare deer such as the sound of an animal being attached by a predator. These devices are off until a headlight of an approaching vehicle is detected and then the emit sound and light to scare the deer off the roadway. The cost of this system is approximately $10,500 per mile.

The Strieter-Lites system came out in the mid 1990s and collects light from the headlights of an approaching vehicle. The light is bounced back and forth across the road way and is reflected by red colored reflectors. A deer attempting to cross the road way sees the red reflected light across the other side of the road. This system runs around $25,000.00 to $30,000 a mile. Aligning the reflectors is critical. This system requires no power supply.

Inventions that utilize sound or sound in combination with light systems to scare deer away from a roadway may suffer from the deer becoming desensitized with the sound and lights. The deer may become familiar with the sounds and lights and cease to be afraid of those systems.

Some states are now experimenting with systems that detect motion and alert motorists by flashing lights. The cost per mile of these systems often exceeds $30,000 per mile. These “animal detection” systems are sometimes used in conjunction with fencing that funnels the deer population into a single crossing point outfitted with motion sensors and flashing lights.

One system developed by Sensor Technologies and Systems (STS) in Scottsdale, Ariz. uses transmitter and microware radio signals in their product. When a large animal crosses a signal's beam, beacons flash on top of signs to warn motorists they could encounter wildlife.

Roadside mounted systems for scaring deer off the roadway are expensive, require maintenance, and may prove to be ineffective.

The vehicle mounted “deer whistle” for scaring deer is inexpensive but may not be effective according to several experts and studies.

### SUMMARY OF THE INVENTION

The hazard warning apparatus is provided for use in motor vehicles enabling a driver observing a road hazard to warn other drivers approaching the hazard. One embodiment of the invention of the hazard warning apparatus is provided for use in a motor vehicle having at least one light forming a hazard warning signal mounted on the body associated of the vehicle in a forward facing direction in order to warn oncoming traffic when illuminated. A power supply circuit provides an intermittently pulsed power signal to the at least one light for a limited period of time in response to an input signal and then automatically turns off. An input switch is located proximate the driver which when engaged, communicates with the power supply causing the array of lights to be intermittently pulsed. In the one preferred embodiment of the invention, the at least one light is an array of lights are formed in the shape of a caution triangle and emit amber colored light. The invention can be either mounted on an inexpensive disposable placard provided with batteries; or alternatively, integrally formed into traditional vehicle components such as inside or outside rearview mirrors.

In one embodiment, the hazard warning apparatus is further provided with a transceiver and an in-vehicle driver warning indicator. When the vehicle driver sees a roadway hazard and activates the warning device, the transceiver emits a local area warning signal. Cars in the local area receiving a local area warning signal activate the in vehicle driver warning indicator to warn the driver of a potential approaching hazard. The wireless hazard signal may be directly transmitted to other vehicles in the immediate vicinity or alternatively, the wireless hazard signal may be indirectly transmitted to vehicles via a GPS enabled cell phone within the vehicle. In this GPS enabled cell phone embodiment, the cell phone upon receipt of the hazard signal from the warning device in the vehicle, transmits a message to a wireless service provider, who, in turn, broadcasts a hazard warning signal to other wireless enabled vehicles operating in the vicinity of the reported hazard.

By providing a transmitter in the hazard warning apparatus, one is able to add a rearward facing auxiliary hazard warning light which is activated automatically when the main hazard warning system is activated by the driver.

### BRIEF DESCRIPTION OF THE DRAWINGS

FIG. 1 is a front view of a vehicle illustrating a placard mounted and an outside rearview mirror mounted version of the hazard warning device;

FIG. 2 is a front view of a the placard mounted version of the hazard warning device;

FIG. 3 is a right side view of the placard of FIG. 2;

FIG. 4 is a bottom plan view of the placard of FIG. 2;

FIG. 5 is a view of the placard of FIG. 2 prior to final assembly;

FIG. 6 is a schematic diagram of the electrical circuit of the first embodiment of the hazard warning device shown in FIG. 2;

FIG. 7 is a schematic diagram of an alternative electrical circuit of the hazard warning device shown in FIG. 2;

FIG. 8 is an inside rearview minor version of the hazard warning device;

FIG. 9 is a schematic diagram of a second embodiment of the hazard warning device;

FIG. 10 is a schematic diagram of auxiliary hazard warning device used in conjunction with the second embodiment of the hazard warning device of FIG. 9;

FIG. 11 is a schematic diagram of a third embodiment of the hazard warning device in relation to other vehicles; and

FIG. 12 is a flow diagram illustrating the operation of the second and third embodiments of the hazard warning device in relation to other vehicles.

### DETAILED DESCRIPTION OF THE PREFERRED EMBODIMENT(S)

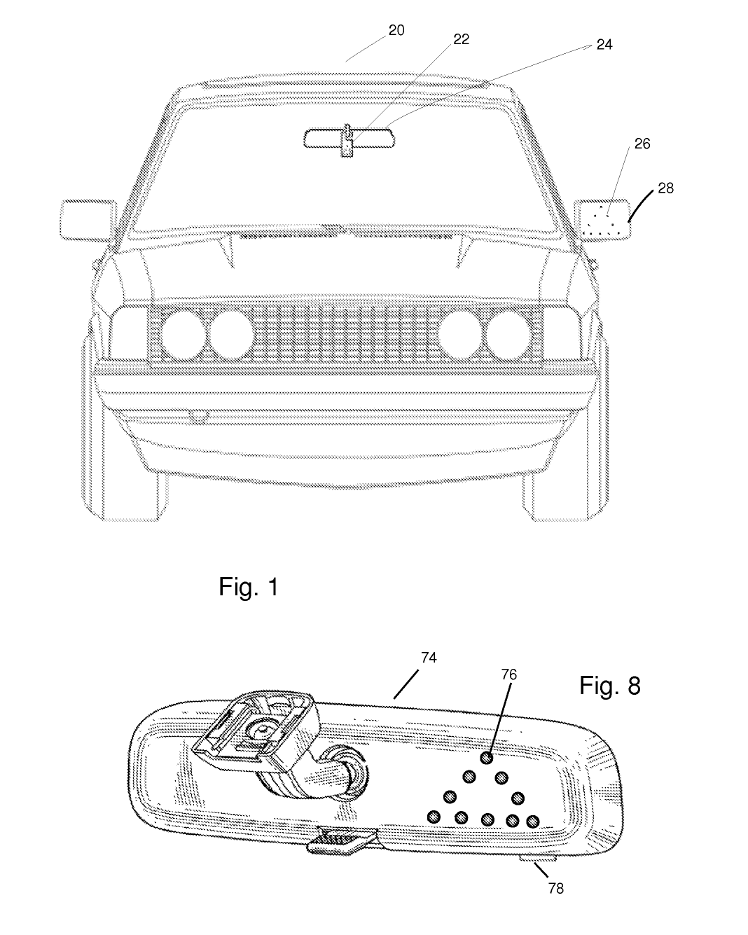

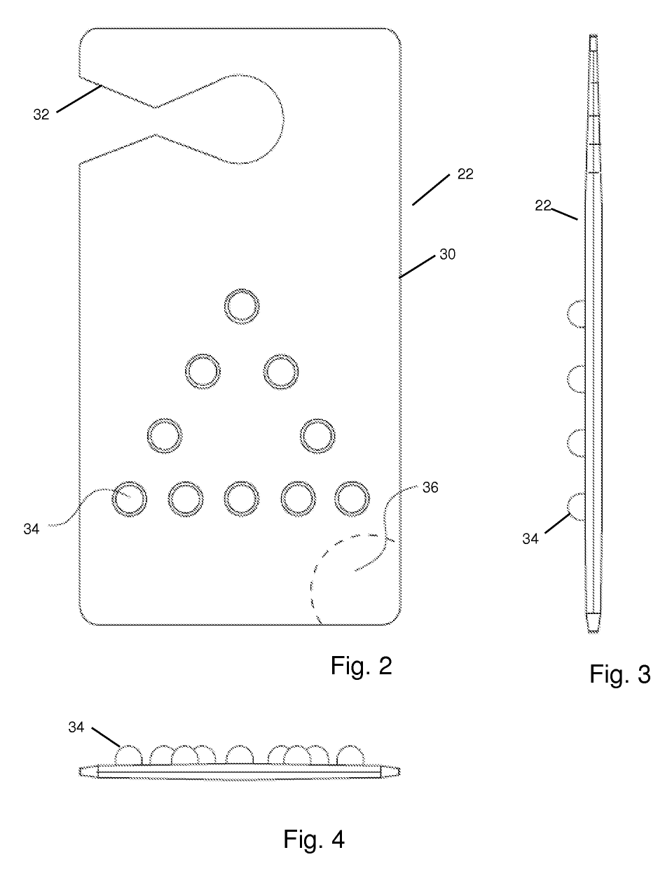

The hazard warning system of the present invention can be implemented in a number of different forms. In FIG. 1, a vehicle 20 is shown, illustrating the placement of a placard type first embodiment of the hazard warning system 22 mounted on the inside rearview mirror 24 and a second embodiment of the hazard warning system 26 incorporated into an outside driver rearview minor 28. The placard type hazard warning system 22 is illustrated in greater detail in FIGS. 2-5. The placard type hazard warning system 22 is in the general shape of a handicap parking permit which is hung from an inside rearview mirror. The placard has a generally planar body 30 provided with a notch 32 in the upper portion thereof for installing the placard on the mounting arm of inside rearview minor. On the front face of the placard illustrated in FIG. 2, an array of lights 34 are provided in the general shape of a caution triangle. The triangle is made up of at least three lights and preferably, six or more lights in order to clearly define a triangle shape. In the lower corner of the placard illustrated in FIG. 2, an input on switch region 36 is defined which, when squeezed by the driver of the vehicle, causes the array of lights to be illuminated in an intermittently flashing manner for a predetermined period of time.

In operation, when a driver of a vehicle sees a roadway hazard such as a deer at the side of the road or other hazards, such as a fallen tree, a rock or a patch of ice, the driver of the vehicle can engage the on-switch 36 causing the lights to intermittently flash for a period of time. The flashing lights are not intended to scare away the deer, but rather, to warn oncoming drivers that they are approaching a hazard and to use caution. In the preferred embodiment illustrated, a standard caution triangle is formed by the array of lights, however, other hazard symbols can be used or even an outline of a deer, however, a triangle universal hazard symbol is preferred using an amber color light. While an array of lights is preferred it is possible to utilize a single high power light source.

By limiting the total duration of the flashing light to one-half to two minutes and preferably, about one minute, false warnings of hazards can be minimized. People familiar with the hazard warning apparatus will know that within a minute of travel time, they will be approaching a potential hazard.

The device is intended to present a hazard message to other motorists in an unambiguous manner so that they will be warned that they are approaching a hazard even if they are unfamiliar with the present invention. The hazard signal of the present invention is unlikely to be confused with other types of warning techniques commonly implemented by those driving at night, such as: flashing vehicle headlights which usually indicates to other drivers that their headlights are off, their high beams are on, or that a trailing motorist wishes to pass, turning on the vehicle's hazard warning lights is typically done to convey that the vehicle is disabled, is being towed, or is being driven at a reduced speed, or tapping one's brake lights is a common warning to trailing drivers to slow down and that a hazard is ahead. There are several types of auxiliary warning lights used by specialty vehicles such as flashing red or blue lights used by police and emergency vehicles and a rotating amber beacon typically used by trucks towing a wide low or plowing snow. It is intended that the present hazard warning indicator provide a unique and unambiguous signal to other drivers in the vicinity that a hazard is ahead unlike other commonly used warning lights.

While the present embodiments of the device are intended primarily for use in low light situations, such as night driving or driving at dusk or early morning, alternative embodiments of the invention can be developed for use in daytime situations by simply using brighter lights during daytime mode of operation. Lights can be provided by a number of different sources such as light emitting diodes (LEDs), OLEDs, incandescent lamps, vacuum florescent lamps, electroluminescent devices, high energy discharge lights or the like. In the preferred embodiment, LEDs are utilized because of their low cost, high light output, low energy usage and total light dispersion pattern characteristics. In the preferred embodiment, the hazard warning lights are flashed which reduce power consumption and makes the light more conspicuous. In the preferred embodiment of the present invention, the hazard warning lights are pulsed on an off at a 15%-25% on duty cycle and most preferably, at a duty cycle of about 20%. The frequency of the light flashes are preferably in the range of 0.5 to 2 hertz and most preferably, about 1 hertz.

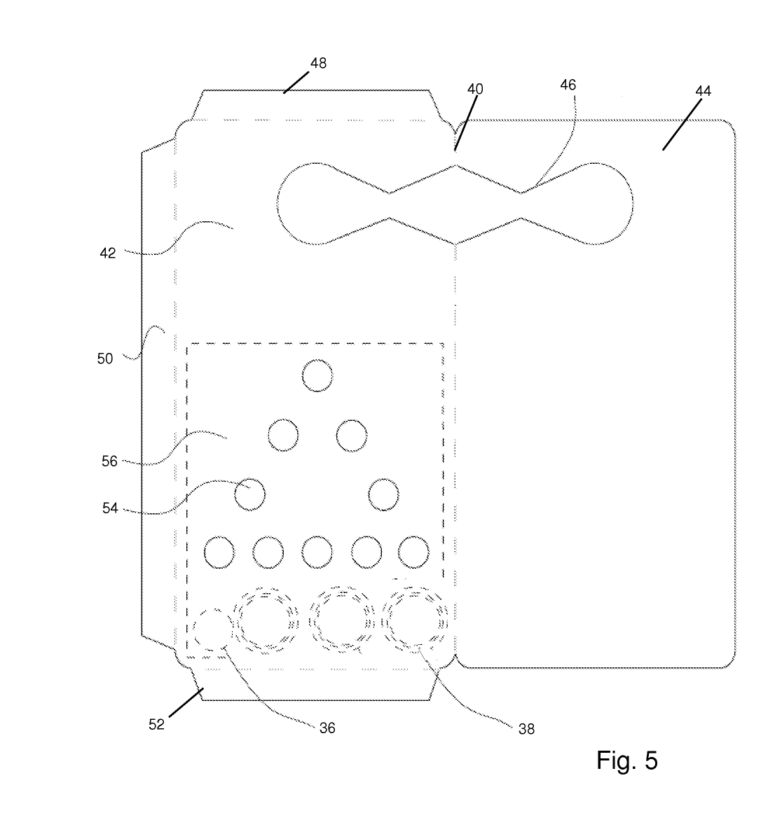

Due to the relatively infrequent expected use of the hazard warning system and the low power usage by the LED light array, it is possible to power placard type hazard warning system 22 with small button type batteries 38 at the location indicated in FIG. 5. With the proper selection of batteries, it is possible to have a placard type hazard warning system that is good for at least two years in typical use and environmental conditions. The preferred battery type is a CR2032 lithium button battery. The source impedance of the lithium batteries may be used to limit the current to the LEDs. Other battery chemistries may require a resistor in series with LEDs to limit current.

It is desirable to keep a placard type hazard warning system as light weight as possible so that it does not become a potential projectile in an automobile crash which could injure the occupants of the vehicle. Accordingly, the placard type hazard warning system 22 illustrated in FIGS. 2-5, has a body 30, made of die cut paper board or alternatively, thin plastic, which is formed in the shape illustrated in FIG. 5. The die cut blank in the illustrated embodiment, has a central fold line 40, a front and back generally rectangular panel 42 and 44; an elongate opening 46 which, when the panel is folded along fold line 40, defines notch 32. In the preferred embodiment, optional glue flaps 48, 50 and 52 are provided to seal the front and back panels together once the electronics are inserted and the device assembled.

As illustrated in FIG. 5, the placard front panel will have a series of apertures 54 punched therein, corresponding to the locations of the array of lights. In the present embodiment, 10 holes are punched in the shape of an equilateral triangle point up; a printed circuit board to which the array of lights 34 are mounted along with a series of batteries 38 and a push type on switch 36 is mounted. Additionally, a power supply circuit (not shown), is mounted on the printed circuit board 56 enabling the entire sub-assembly to be placed in the placard body as shown in FIG. 5 and the unit assembled by folding the front and back flaps together and sealing the unit shut by folding glue flaps 48, 50 and 52 into position as illustrated in FIGS. 2-3. Preferably, the LED lights 34 will protrude from the front face of the front panel as illustrated in FIGS. 3 and 4.

The placard body 30 is preferably printed using conventional printing techniques to provide instructions and other graphics on the front and rear exposed faces of the front and back panels 42 and 44. In addition to graphics, the body in the preferred embodiment is imprinted with a conductive ink which acts as a ground plane minimizing electronic interference as well as a UV protective coating to protect the graphics from degradation due to sunlight.

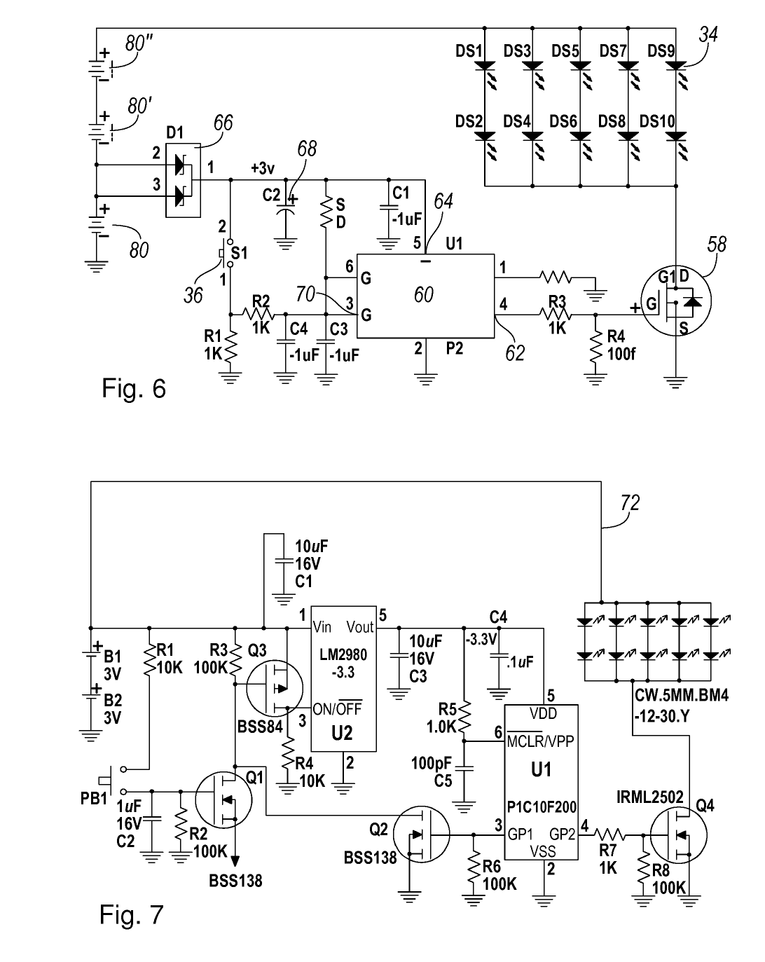

In FIG. 6, the schematic illustration of a representative electrical circuit utilized in placard type hazard warning system 22 is shown in FIGS. 2-5. This entire electrical circuit is mounted on a printed circuit board 56. The circuit is powered by three button type batteries 38, 38′ and 38″. In the preferred embodiment, these batteries are lithium ion type because of the low leakage, high powered density and high source impedance, however, other types of batteries could be used. Each battery has a three volt, no load output, which collectively, define a +9 volt input to LED array 34. The array of ten LEDs 34 oriented in a series parallel manner with five parallel legs, each leg having two LEDs in series. The flow of current through the array of LEDs is regulated by FET 58 which is connected to ground. The gate input to FET is powered by the output 62 of microprocessor 60. The output signal of the microprocessor 60 is a series of intermittent pulses having the desire to cycle frequency for a predetermined period of time. As previously described, preferably, the cycle is approximately 20% and the pulse frequency is one hertz lasting for a period of approximately of one minute, each time the driver presses the switch 36.

The input terminal 64 of the microprocessor 60 is connected to the output of one of the batteries, battery 38, via a diode pair 66 limiting the no load power to 3 volts. Diode 66 in conjunction with capacitor 68 insures an adequate voltage supply to the microprocessor as the battery voltage drops as current is drawn during a life flash event. Preferably, the power to the input terminal 64 of microprocessor 60 stays above 1.8 volts. During the flash event, the voltage across a single battery cell may drop below 1.8 volts. During this intermittent time, energy is stored in capacitor 68 coupled is discharged while diode 66 prevents the reverse flow of current. This circuit design feature maintains adequate power of the microprocessor during maximum current draw periods. The other capacitors and resistors in the circuit form conventional RC filters to eliminate noise and electrostatic interference.

In the normal state with switch 36 in the open or off position. When the circuit is inactive for a period of time the microprocessor goes into a sleeper mode in which there is an extremely low current draw. When the driver engages switch 36, the switch is momentarily closed sending an “on” signal to the microprocessor input port 70. The microprocessor then begins its programmed cycle intermittently providing an output signal at port 62 which drives the gate of FET 58. Output signal 62 intermittently pulses at a 15% to 25% duty cycle and preferably, 20% duty cycle at a frequency of 0.5 to 2 hertz and preferably, 1 hertz. Pulses continue for 0.5 to 2 minutes or preferably, about 1 minute, whereupon , the microprocessor output ceases and after a period of time resumes the sleep or power saving mode. Any number of microprocessors are suitable for this circuit. In this preferred embodiment, a microprocessor from Microchip was used. This microprocessor is preprogrammed prior to being mounted to a thin, flexible PC board.

Preferably, lights 34 are LEDs having a limited light dispersion pattern. Ideally, the light dispersion pattern will be sufficiently narrowly focused to provide an intense light signal to oncoming traffic, but, be sufficiently wide so that the LEDs remain in view until just prior to the vehicles in adjacent lanes are passing one another in opposite directions. Preferably, the total included angle of the dispersed light will vary from centerline 15° to 40° and most preferably, 25° to 35°. In the embodiment illustrated, the LEDs have a light dispersion angle of about 30° and provides a good compromise between light intensity at a distance and the proximity between adjacent vehicles in different lanes which the primary beam of the light is no longer in view. A narrow dispersion angle also reduces the reflection of light of the windshield back at the driver. Of course, even at a near 90° angle the LEDs will be illuminated at some very low light level due to inherent light scatter. The light dispersion angle refers to the primary beam of the light, This angle is commonly reported by LED manufactures.

The circuit of FIG. 6 is just one of numerous circuits which could be developed of one of ordinary skill in the art to provide the desired flashing light function. Circuits will vary depending on the type and number of batteries used and the type and number of lights used, the microprocessor selected, as well as other cost and performance factors. An example of an alternative power supply circuit 72 is shown in FIG. 7. This circuit is described in detail in the provisional application, Ser. No. 61/200,458, which is incorporated by reference herein. It is believed, however, that FIG. 6 provides a more cost efficient and better performing power supply circuit. Again, it should be appreciated that numerous other circuit designs can be utilized in practicing the invention which is not limited to any particular power supply circuit.

FIG. 8 illustrates an inside rearview minor 74, yet another embodiment of the invention. The forward facing surface of the housing of minor 74 is provided with at least one hazard warning light 76. Preferably, the hazard warning light is made up of an array of LEDs forming a caution triangle, however, it should be appreciated that other shaped array of lights or even a single high power LED could be used to practice the present invention. The advantage, however, of having an array of lights, is that a warning symbol such as a crossing triangle or other shapes could be used in order to immediately convey to an untrained observer, that the light is intended to provide a warning. It should be noted, however, that even a relatively large triangle array of LEDs will be perceived as a single light source at a far distance. Only when one becomes relatively close to the LED array in the oncoming car, does the triangle shape of the array become perceptible.

Mirror 74 is further provided with a hazard “on” switch 78 in an orientation which can be easily activated by the driver of the vehicle. The hazard warning light in the FIG. 8 embodiment can be powered by batteries as described previously or connected through a power line not shown to the vehicle's battery. It should be appreciated that hazard warning lights can be incorporated into any number of a variety of configurations. A hazard warning light can be included in other vehicle components such as the dash or grill. Alternatively, other stand alone, add-on devices can be used as an alternative to the placard 22. One example would be a hazard warning light which could be affixed to the windshield in an area which did not block the driver's view such as behind or above the inside rearview minor. The hazard warning light could alternatively be attached to the vehicle windshield or dashboard using suction cups of two-sided mounting tape.

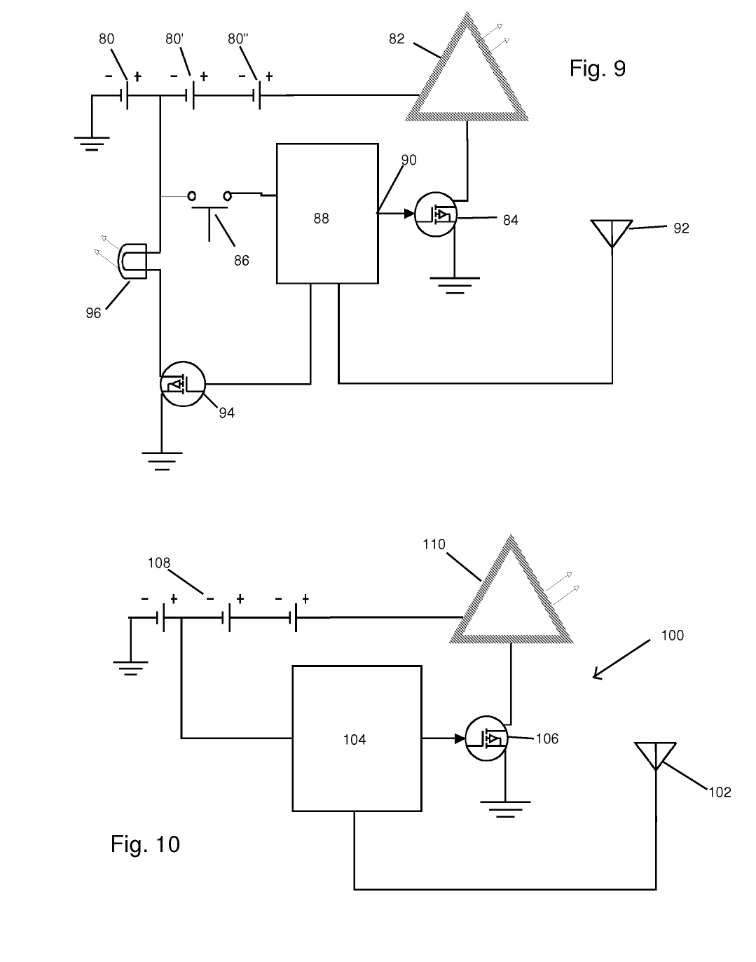

FIG. 9 illustrates a hazard warning system 78 forming a fourth embodiment of the invention having an increased functionality. A simplified electrical circuit is shown and fabricated, preferably. A combination of a diode and a storage capacitor described with reference to FIG. 7 schematic will likewise be incorporated along with an RC filter to reduce effective or electronic noise. Hazard warning system 78, similar to the FIG. 7 embodiment is provided with a series of batteries 80, 80′ and 80″, which are connected to a hazard warning light 82. Preferably, hazard light 82 is an array of LEDs pointed in a series parallel arrangement as described previously and connected to ground series through FET 84. Like the FIG. 7 embodiment, the operation of the hazard warning system is initiated by a push to close switch 86 which is actuated by the vehicle's own driver. Switch 86 provides a pulse power input to a transceiver 88 which includes a microprocessor. The transceiver has a power output 90 connected to the gate of FET 84. When the “on” switch 86 is depressed, the microprocessor internal to transceiver to 88 will generate a pulse power output at a control duty cycle and a frequency for a limited power of time and as described previously. The transceiver 88 is further provided with an output connected to antenna 92 which causes an RF hazard signal to be broadcast when the hazard warning system is engaged.

In a simple form of the present invention, this wireless hazard warning signal can be detected by other vehicles in the vicinity having like constructed hazard warning system. When a vehicle that has a warning system detects a wireless hazard signal broadcast by another vehicle, the microprocessor and transceiver 88 will provide an output to the gate of FET 94 which connects in-vehicle driver warning light 96 to providing a visual indication of a potential hazard in the area to the driver. (FET 84 which controls light array 82 is not activated.) It should be appreciated the multiple hazard switches can be provided which would broadcast a different wireless signals in order to be able to specifically identify two or more different hazards such a general warning of deer spotted in the area verses a prepare to emergency stop the roadway is closed.

The driver warning light 96 is preferably mounted on the placard on the side the faces the driver. The warning may be also communicated to the driver with an audible alarm. Drivers receiving the alarm could be trailing the vehicle issuing the hazard warning or be on a side road out of direct line of sight of the hazard warning light, yet, they would have the benefit of the hazard warning. Since the in vehicle warning light will be proximate the driver, a very low power light and/or an audible alarm could be used. The in vehicle warning alarm light 96 may or may not flash depending upon the preference of the system designer, nor does the in vehicle warning alarm need to operate before. Since the in vehicle driver alarm could be relatively unobtrusive and utilize very little power, the duration of the in vehicle warning light is not an issue in system design.

FIG. 10 illustrates an auxiliary hazard warning light 100 which could be installed in a rearward facing location adjacent a vehicle rear window. Auxiliary hazard warning light 100 is similar in some respects to hazard warning system 78, however, there is no “on” switch for activation by the driver of the vehicle. Auxiliary hazard warning light 100 is provided with an antenna 102 which can detect the wireless hazard warning signal broadcast by the main hazard warning system 78. When the hazard warning signal is detected by the receiver 104, a microprocessor within the receiver will issue an intermittent pulse to drive the gate of FET 106 which in turn, connects the battery array 108 and the LED array 110 to ground causing the LED array to be intermittently limiting in a pulsating manner for a predetermined period of time. Of course, the auxiliary hazard warning light 100 will be provided with a similar diode storage capacitor as shown in FIG. 6 in order to maintain adequate power to the microprocessor within transceiver 104. Appropriate RC filters will be added to eliminate interference from noise.

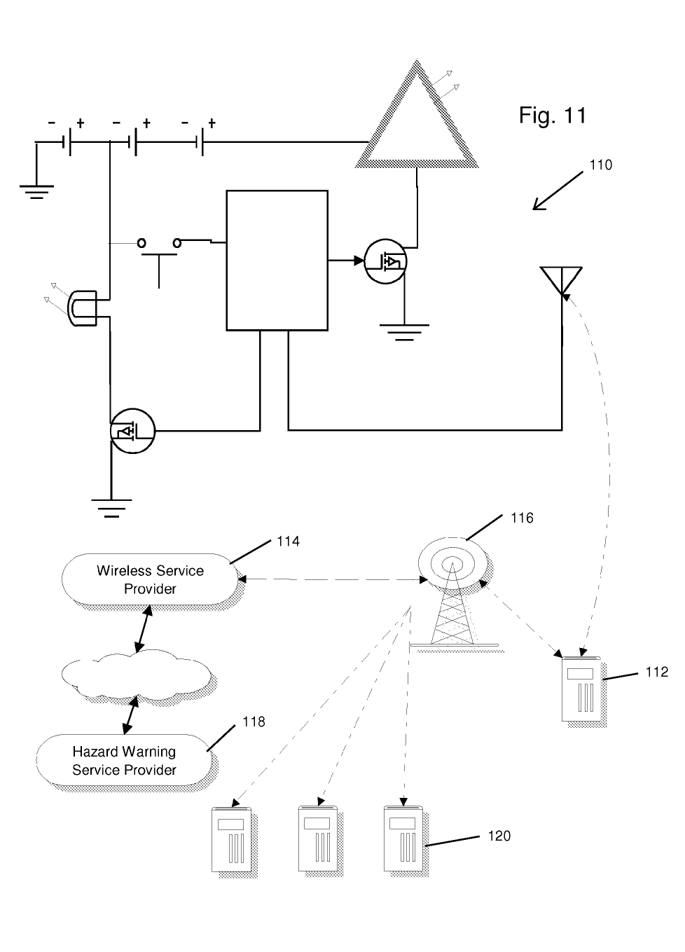

FIG. 11 illustrates an alternative embodiment of the hazard warning system having a circuit similar to the hazard warning apparatus 78 of FIG. 9, but, rather than directly broadcasting a wireless hazard warning signal to adjacent vehicles, a wireless signal, such as a Blue Tooth signal will be provided to an on vehicle GPS enabled cell phone 112. Cell phone 112 will, in turn, communicate with a wireless cell phone provider 114 via a local cell tower 116 and transmit a hazard signal which will include the GPS coordinates of the vehicle at the time the hazard system was actuated. This information, along with the caller ID of cell phone 112 will be processed in a computer based warning system either at the resident of the cell phone provider or resident at a third party hazard warning service provider which receives information from more than one service provider. Upon receipt of the hazard warning information, hazard warning signals can be specifically issued to other operating motor vehicles equipped with GPS enabled cell phones in the vicinity of the reporter hazard. Preferably, other vehicles are equipped with a hazard warning system 110, however, that is not necessary. All that is necessary is they have a GPS enabled cell phone 120 and about to end to the hazard warning service. Upon receipt of a hazard warning broadcast signal, the GPS enabled cell phone can issue a warning audible signal and/or the GPS enabled cell phone can communicate with the hazard warning system via Blue Tooth link and activate a vehicle warning driver light as described with reference to system 78 of FIG. 9. Alternatively, once the system has achieved widespread adoption it would be possible to make a GPS enabled cell phone hazard warning system without the use of a forward facing flashing warning light, relying solely on the cell phone warning.

By having a centralized hazard warning system provider, the system can become very intelligent. For example, a hazard is detected on a Northbound lane of a divided expressway, only drivers that are Northbound approaching the hazard need to be warned. Southbound traffic or traffic on adjacent streets need not be warned of the hazard. Similarly, the duration that the hazard is active can be greatly extended since only those people approaching the hazard need be notified. With a centralized hazard warning, it is also possible to notify local police or a GPS based route planning systems of the hazard in a very timely manner.

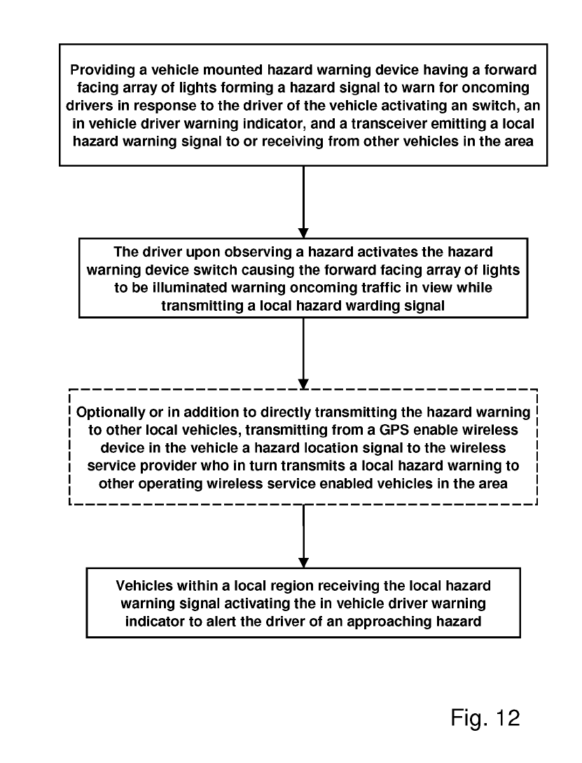

FIG. 12 illustrates a block diagram describing the method of operation of the transceiver hazard warning system embodiments of FIG. 7 and FIG. 11. Vehicles are provided with hazard warning device having a forward facing hazard warning light warn oncoming drivers in response to a driver activating a hazard switch in the vehicle. The vehicles are additionally provided with an in vehicle driver warning indicator and a transmitter for emitting a local hazard warning signal to or receiving a signal from other vehicles in the local area. When a driver observes a hazard, the warning device may be activated causing the forward facing array of lights to be illuminated and simultaneously transmitting a local hazard warning system. In the FIG. 7 embodiment, the signal is received directly by other vehicles in the region and the in vehicle driver warning light or other indicator is activated to let the driver know of an approaching hazard. In the FIG. 11 embodiment as described previously, the transceiver will emit a wireless command to a GPS enabled wireless device in the vehicle so that a hazard warning location can be transmitted to a wireless service provider. Upon receipt of the hazard warning signal, the provider can transmit a local hazard warning to other vehicles having a GPS enabled wireless device which would likely encounter the hazard if continuing on their current path. It should be appreciated that a great number of different features can be designed in the centralized hazard warning system providers so that a very reliable hazard warning can be issued to those likely to encounter hazards without needlessly alarming others in the vicinity that have already passed or are unlikely to encounter the hazard based upon their traveled path.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A hazard warning apparatus, comprising:
a body adapted to be mounted within an occupant cavity of a motor vehicle proximate a windshield, the body have a first surface having a first surface facing generally forward toward the windshield;
at least one light mounted relative to the body first surface forming a hazard warning signal when illuminated;
a power supply circuit for providing an intermittently pulsed power signal to the at least one light for a limited period of time in response to an ON input signal and then automatically turn off; and
an input switch located with reach of a driver of the motor vehicle which when engaged communicates an ON input signal to the power supply to cause the at least one light to be intermittently pulsed providing a warning visual to oncoming traffic of an approaching hazard.

2. The hazard warning apparatus of claim 1 wherein the at least one light is an array of lights are arranged in the shape of a caution triangle.

3. The hazard warning apparatus of claim 1 wherein the at least one light provides an amber colored light output.

4. The hazard warning apparatus of claim 1 further comprising at least one battery for powering the power supply circuit independent the motor vehicle.

5. The hazard warning apparatus of claim 4 wherein the body further comprises a generally planar placard to which the at least on battery and input switch is mounted.

6. The hazard warning apparatus of claim 5 wherein the placard further comprises a hook-like portion enabling the placard to be hung behind an inside rear view minor with the placard first surface facing the windshield.

7. The hazard warning apparatus of claim 1 wherein the at least one light comprises an array of at least six LEDs arranged in the shape of a caution triangle having an amber colored light output.

8. The hazard warning apparatus of claim 7 wherein the power supply pulses the array of lights at a 15 to 25% ON duty cycle, at a frequency of 0.5 to 1.5 Hz for a duration of 0.5 to 2 minutes when the input switch is engaged by the driver of the vehicle.

9. A hazard warning apparatus, comprising:
at least one warning light mounted to a forward facing surface of a body associated with a motor vehicle forming a hazard warning signal for oncoming traffic when illuminated;
a power supply circuit for providing an intermittently pulsed power signal to at least one warning light for a limited period of time in response to an ON input signal and then automatically turn off; and
an input switch located with reach of a driver of the motor vehicle which when engaged communicates an ON input signal to the power supply to cause the at least one warning light to be illuminated.

10. The hazard warning apparatus of claim 9 wherein the at least one warning light is an LED light have a primary beam dispersion angle of 20° to 40° and are generally amber in color.

11. The hazard warning apparatus of claim 9 wherein the body associated with the motor vehicle to which the at least one warning light is mounted is a forward facing portion of a rearview mirror.

12. The hazard warning apparatus of claim 9 further comprising a driver warning light, a transceiver capable of sending a wireless hazard signal when the input switch is engaged by the driver and receiving a wireless hazard signal, and a driver warning light power supply circuit in communication with the transceiver which illuminates the driver warning light for a limited period of time to warn the driver that another vehicle in the local area has encounter a hazard upon receipt of a wireless hazard signal.

13. The hazard warning apparatus of claim 12 wherein the wireless hazard signal is broadcast directly to other vehicles in the local area equipped with a compatible hazard warning apparatus.

14. The hazard warning apparatus of claim 12 wherein the wireless hazard signal is broadcast indirectly to other vehicles in the local area by communicating with a GPS enabled wireless device in the vehicle causing a hazard warning and location to be forwarded to a wireless service provider who in turn sends hazard warnings to other wireless device equipped vehicles in the local area of the reported hazard.

15. The hazard warning apparatus of claim 9 further comprising a transmitter capable of sending a low power wireless hazard ON signal when the input switch is engaged by the driver and an auxiliary hazard warning apparatus, the auxiliary hazard warning apparatus comprising:
a wireless receiver for receiving the low power wireless hazard ON signal and generating an auxiliary ON signal;
at least one warning light mounted to a rearward facing surface of a body associated with a motor vehicle forming a hazard warning signal for following traffic when illuminated; and
an auxiliary power supply circuit for providing an intermittently pulsed power signal to the at least one warning light for a limited period of time and then automatically turn off upon receipt of an auxiliary ON signal.

16. The hazard warning apparatus of claim 15 wherein the auxiliary hazard warning apparatus further comprises at least one battery for powering the auxiliary power supply circuit independent the motor vehicle.

17. The hazard warning apparatus of claim 16 wherein the at least one warning light includes at least six LEDs arranged in the shape of a caution triangle having an amber colored light output.

18. A method for enabling a driver of a motor vehicle to warn oncoming traffic of a road hazard, comprising:
providing a hazard warning device having at least one light forming a hazard warning signal when illuminated on a forward facing surface of a body associated with a motor vehicle and a power supply circuit generating an intermittently pulsed power signal to the at least one light for a limited period of time response to an ON input signal from a driver activated switch;
wherein oncoming traffic can be warned a hazard in the general vicinity by drivers of approaching vehicles who have activated their hazard warning device illuminating the at least one light.

19. The method of claim 18 further comprising providing a driver warning light, a transceiver capable of sending a wireless hazard signal when the input switch is engaged by the driver and receiving a wireless hazard signal, and a driver warning light power supply circuit in communication with the transceiver which illuminates the driver warning light for a limited period of time upon receipt of a wireless hazard signal to warn the driver that another vehicle in the local area has encounter a hazard.

20. The method of claim 19 wherein a wireless hazard signal is broadcast indirectly to other vehicles in the local area by communicating with a GPS enabled wireless device in the vehicle causing a hazard warning and location to be forwarded to a wireless service provider who in turn sends hazard warnings to other wireless equipped vehicles in the local area of the reported hazard.
